(19) United States
(12) Patent Application Publication
(10) Pub. No.: US 2007/0094075 A1
(43) Pub. Date: Apr. 26, 2007

(54) Coupon Book and Methods of Design and Use Thereof

(76) Inventors: Gary Graham, Centennial, CO (US); Michael Oliver, Royal Tunbridge Wells (GB)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/464,039

(22) Filed: Aug. 11, 2006

Related U.S. Application Data
(60) Provisional application No. 60/707,262, filed on Aug. 11, 2005.

(51) Int. Cl. G06Q 30/00

(52) U.S. Cl. 705/14

(57) ABSTRACT

Embodiments of the present invention describe a system for designing and generating customized coupon books of any size. The system comprises an Enterprise Resource Product (ERP) that is connected to a network over which users of the system can access the ERP. The system includes functionality permitting a user to choose each and every coupon to be included in the book, as well as, design specific coupons to be included in the book. A database of all available coupons is provided to the user to assist in the design and customization process.

### REFERENCE TO RELATED APPLICATIONS

This application claims priority to and incorporates herein in its entirety the provisional application No. 60/707,262 filed on Aug. 11, 2005 having the same inventors and title as this application.

### FIELD OF THE INVENTION

This invention relates to coupons, coupon books and methods related to designing, producing and tracking coupons and coupon books.

### BACKGROUND

Books or other bound material comprising a plurality of coupons or other related offers (hereafter “Coupon Books”) are relatively common. Coupon books come in a myriad of formats from small coupon booklets containing a relatively small number of coupons to large bound books containing hundreds if not thousands of coupons.

The smaller coupon booklets are often produced by marketing or advertising companies (hereafter “small coupon booklet producers”) and distributed by any suitable means including but not limited to mailings and giveaways at events. More often than not these booklets are provided without cost to the consumer. Small coupon booklet producers usually solicit vendors of goods and services located within a geographic region to advertise in the book. The venders typically pay a significant amount of money for inclusion in the book and the money received from all the vendors in a particular booklet represents the revenues earned by the small coupon booklet producer concerning the booklet.

Larger coupon books are often sold to consumers and contain a large number of coupons that create a high perceived value by the consumers. In some communities, large coupon books can have substantial distribution and good name recognition among consumers. These books are sold and distributed through a number of venues including: (i) retail establishments; (ii) school and charitable fundraisers; and (iii) directly from the book's producer, such as through a web site. One large coupon book that is particularly popular in the United States is the Entertainment™ Book of which different books are produced for various metropolitan areas around the country. Unlike smaller coupon booklets, vendors often do not pay to be included in a large coupon book; however, the decisions on what vendors and coupon offers to include or not to include in the book are made solely by the large book's producer. Generally speaking, the revenue generation models used by large book producers are not transferable to producers of small coupon booklets since the typical prior art coupon booklets do not have a high perceived value among consumers. Stated another way, consumers are unwilling to purchase traditional prior art small coupon booklets.

Essentially, small coupon booklets and more generically advertising circulars and mailers are advertising vehicles and as such the small coupon booklet producers generate most of their revenues by selling space in the booklets to vendors who want to increase their exposure with a targeted segment of the consumer population. In other words, the focus of the small coupon booklet producer is on signing vendors to generate revenues for the small coupon booklet producer.

While some of the large coupon book producers are known to sell books specifically branded to reflect a certain distributor or provider of the books, the large coupon book producers only have the capability of preparing custom branded books in very large quantities. For example, a book may be prepared and branded exclusively for a cable company or perhaps a newspaper that will distribute tens of thousands of the books in a metropolitan region to its customers as a gift of appreciation or for some other promotion. Even with these books, the large clients purchasing the books are not able to customize the book by picking each coupon to be included in the book. They are usually only permitted to pick category types for inclusion in the book, and at best, they may be able to pick specific pages from larger coupon books that contain a grouping of coupons.

The large coupon book and small coupon booklet producers, however, are unable to cost effectively prepare customized and branded coupon books for smaller entities, such a small local companies, smaller charities, specific schools, and other entities wherein the number of books required is less than several thousand. For example, when dealing with smaller companies, charities and entities, Entertainment Publishing Inc., the producer of the Entertainment™ book, provides the same Entertainment™ book to these entities that can be purchased through other retail channels. The books do not carry the fundraising entity's logo or message (unless added as an afterthought by the fundraising entity as an appliqué); the books do not contain customized offerings related to the particular fund raising entity; and the fundraising entity is not able to specifically choose the coupons and offers that will appear in the book.

As mentioned above one of the primary problems with small coupon booklets is that they have a low perceived value with consumers. Part of the problem is the manner in which these small coupon booklets are typically distributed: i.e. as junk mail and/or low threshold free giveaways. Another significant contributor to the low perceived value can be attributed to the form and format of the booklets. Many booklets are simply staple bound with a card stock paper cover that includes a significant amount of flashy printing on them. Booklets that are perfect bound are also known but they still have card stock covers often with the same or similar flashy printing. Alternatives to the smaller coupon booklets, namely coupon mailers, suffer equally if not worse from the perceived value problem. Mailers typically comprise envelopes with flashy printing that contain a number of loose leaf coupons and offers.

Yet another reason for the low perceived value of typical small coupon booklets is their content. The small coupon booklet producers charge vendors to be included in the booklet. They will usually accept just about any vendor provided it is able to pay the appropriate fee. Accordingly, the type of vendors you will find in a typical small coupon booklet or mailer are often very predictable. For instance, very few small coupon booklets exist that do not have coupons for HVAC companies, restaurants and tire and/or muffler companies among the offerings. Because of the particular vendors, and the types of vendors found in these booklets, users often develop the belief or feeling that the price charged by the particular vendors is a fair price only if a coupon is involved. In other words, the consumer does not feel he/she is getting a special or hard to come by deal when he/she uses a coupon from one of these booklets. Further, the consumer also realizes that because of the proliferation of these free booklets and mailers, he/she can obtain a coupon of the type that is found in these booklets with relative ease. Accordingly, the level of importance the consumer places on coveting any particular booklet he/she comes across is reduced substantially.

Of course, the low perceived value of the smaller coupon booklets make them generally ineffective as giveaways. When a company is promoting itself, it typically desires to giveaway items having a much higher perceived value than what the item cost. Traditional prior art coupon booklets just do not fit into that category of items. Further, trying to sell small coupon booklets, such as for school or charity fundraisers, is particularly difficult and futile.

### BRIEF DESCRIPTION OF THE DRAWINGS

FIG. 1 is an illustration of a coupon booklet cover resembling a typical bank checkbook cover according to one embodiment of the present invention.

FIG. 2 is an illustration of a coupon booklet resembling a typical bank checkbook according to one embodiment of the present invention.

FIG. 3 is an illustration of an exemplary coupon that resembles a typical bank check according to one embodiment of the present invention.

FIG. 4 is a block diagram depicting the Marketing Resource Center (MRC) engine utilized in designing coupons and coupon books, ordering coupon books and tracking information related to the use of the coupons and the activities associated with the coupon books according to one embodiment of the present invention.

FIG. 5 is a flow chart illustrating the process of creating and ordering a coupon book according to one embodiment of the present invention.

FIG. 6 is a flow chart illustrating the processes associated with capturing and disseminating information and data related to the use of the coupons and the coupon books.

### DETAILED DESCRIPTION

Embodiments of the present invention describe a coupon booklet containing a small number of coupons (preferably less than about 100 coupons, more preferably less than 50 coupons and most preferably about 30 coupons or less) wherein: (i) the booklet is configured to substantially resemble a personal checking account checkbook; and (ii) the coupons themselves substantially resemble personal bank checks. In some variations, the name and/or logo of the provider of the booklet is printed and/or embossed on the checkbook cover, which is typically comprised of, but not limited to, vinyl or another polymeric material. In some variations, the coupons include numerical marking in locations similar to where bank checks are numerically marked. The numerical markings can be coded to provide information concerning the coupon such as but not limited to: (i) the booklet the coupon was offered in; and (ii) the geographic area in which the associated booklet was distributed. In other variations, the coupons include a line with indicia indicating that the email address of the person redeeming the coupon is to be entered. The email address line is located proximate the location in which the signature line appears on a bank check.

Other embodiments of the present invention describe a system for designing and generating customized coupon booklets and coupon books of any size. The system comprises an Enterprise Resource Product (ERP) that is connected to a network over which users of the system can access the ERP. The system includes modules and software scripts permitting a user to choose each and every coupon to be included in the book, as well as, design specific coupons to be included in the book. A database of all available coupons is provided to the user to assist in the design and customization process. Additional modules and software permit the user to customize the book's cover and enclose other information the user want to impart to the receipts of the book. Typically, the network comprises the Internet and the entire process can be completed over the Internet from any suitable computer or network appliance. Several variations of the system also include activity tracking modules to monitor and manage access to the system by user. Other variations include analysis modules that can utilize the email addresses and numerical data on redeemed and returned coupons to generate information useful to clients, vendors and the book's producer. Further, other variations include marketing materials that a salesperson can access to present information concerning the coupon book product to prospective clients. It is appreciated yet other variations of the system permit the design and customization of not only coupon booklets but also large coupon books and coupon mailers.

Yet other embodiments of the present invention describe methods of utilizing the described system and the described coupon books. As taught in an embodiment concerning the methodology of creating a coupon book, a user logs on to an ERP by way of a network connection, such as through the Internet. Through modules available on the ERP, the user designs a coupon booklet by: (i) designing one or more of the coupons to be included in the booklet, as well as, be made available for other clients for their future use; and (ii) choosing other coupons from a database of coupon offers from other vendors. In some variations, the user can also design a cover and/or welcome pages for the coupon book. In other variations, the user also orders the desired number of coupon books through the ERP. In yet other variations, the user may view a marketing and/or sales presentation as provided through the ERP.

As taught in an embodiment concerning the processing of data related to redeemed coupons, a vendor returns the coupons to the coupon book producer by any suitable means including but not limited to mailing the coupons back to the producer in postage prepaid envelopes. Next, the producer enters data into the ERP or other related database application. The data can include but is not limited to: the names and email addresses of the coupon redeemers; an encoded number identifying the coupon book that the coupon was removed from; an encoded number indicating the geographic region the book was distributed in; an encoded number relating to the vendor; and the date when the book was produced. In some variations, some or all of the data may be entered into the ERP or database automatically using optical character recognition when the coupons are scanned into a computer system. In other variations, the producer will either automatically or manually will verify the email address provided on any particular coupon prior to sending a list of email addresses to the vendor who offered the coupon. After all the available data has been entered into the system, it is analyzed to provide desired information to the vendors, the producer and/or the client for whom the book(s) was produced. Finally, the information is sent to the appropriate parties.

### DEFINITIONS AND TERMINOLOGY

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “embodiments”, “variations”, “a variation” and similar phrases means that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The term “coupled” refers to two or more elements that are connected together but not necessarily directly connected together.

As applicable, the terms “about” or “generally” as used herein unless otherwise indicated means a margin of ±20%. Also, as applicable, the term substantially as used herein unless otherwise indicated means a margin of ±10%. It is to be appreciated that not all uses of the above terms are quantifiable such that the referenced ranges can be applied.

The terms “coupon” or “coupons” as used herein refer to any discount offer that is printed on a substrate. The discount offer can of any form, such as but not limited to: a monetary amount; a percentage discount; a buy one get one free offer; a give away offer. Generically, a coupon can comprise any printed offer of an item or service for less than its usual or retail price that is sometimes subject to certain conditions and requirements. For instance, tickets to a sporting event included in a coupon booklet are coupons for purposes of this disclosure.

As used herein, the term “booklet” as it relates to coupons refers to a bound assembly of coupons having a total of about 100 coupons or less. As used herein, the term “book” refers to any bound assembly of pages including “booklets” and larger assemblies. A “large coupon book” is typically a book of well over 100 coupons.

As used herein, the terms “vendor” and/or “merchant” refer to an entity making or tendering the offer on a particular coupon unless the context in which the term(s) is used clearly indicates otherwise. Often a “vendor” or “merchant” will also be a “client”.

As used herein, the term “client(s)” refers to an entity for whom or by a coupon book is designed and produced. The entity for whom a coupon booklet is produced is also referred to herein as the entity “sponsoring and/or providing” the booklet or similar terms.

As used herein, the terms “producer”, “book producer” and/or “booklet producer” refers the maker of a coupon book, i.e. the entity responsible for the production of the coupon book.

As used herein, the terms “coupon mailer” and “coupon circular” refers to an assembly of unbound coupons often, but not necessarily, distributed by the postal service through the mail. It is appreciated that the methodologies and systems described in this disclosure can be applied to mailers and circulars in addition to books and booklets.

As used herein, the term “entity” refers to any person or legally organized entity of any state or nation.

The Coupon Booklet

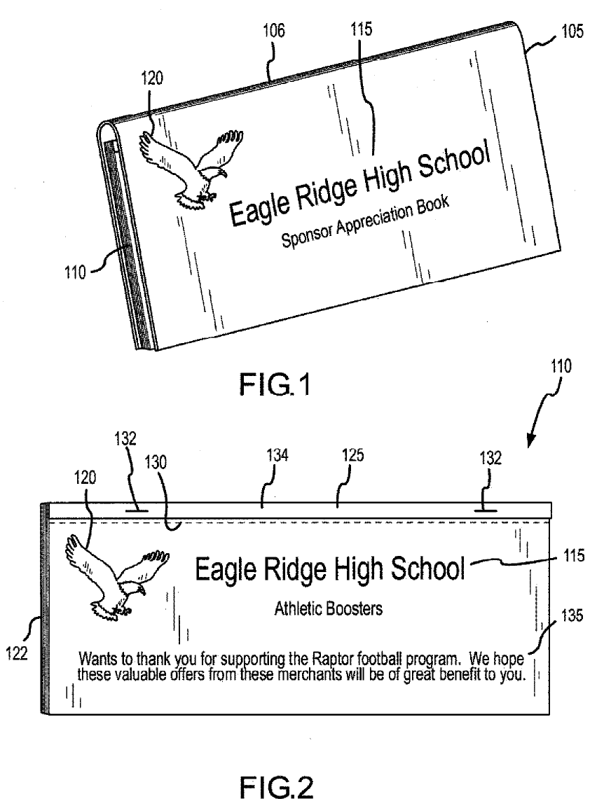

Referring to FIGS. 1-3, a coupon booklet 100 according to one embodiment is illustrated. The coupon booklet is configured to be substantially similar and reminiscent of a typical checkbook and includes a cover 105 and a plurality of coupons bound in a booklet insert 110 in a form similar to bound personal bank checks wherein each coupon is perforated to permit easy removal.

In certain embodiments, the cover 105 is essentially identical to checkbook covers provided with an order of traditional personal bank checks. Specifically, the cover is typically comprised of vinyl or a similar polymeric material and is creased and/or folded along a top lengthwise edge 106. A pocket is typically provided on one or both inside surfaces of the front and back sides of the cover to facilitate sliding a rear sheet 122 (see FIG. 2) of a coupon booklet insert 110 therein to secure and hold the booklet in the cover. In a preferred variation, the cover is about 6.25 inches in length and about 3.25 inches in width, which is the typical size of a similar standard checkbook cover. It is appreciated that the dimensions may vary somewhat in alternative embodiments and variations.

While the cover 105 is usually made of vinyl in one preferred embodiment, it is not limited to this material in other variations or embodiments. For example, the cover could be made of other polymeric materials; leather or even paper, such as cardboard. In some variations, such as a cardboard cover, the cover need not include interior pockets to hold the rear sheet 122 of the coupon booklet insert 110, but rather the rear sheet of the coupon booklet could be mechanically or adhesively fastened to the back side of the cover. In yet another variation, the cover may be an integral part of the coupon booklet insert wherein it is bound together with the coupons along the top lengthwise edge of the plurality of coupons.

Referring specifically to FIG. 1, the front surface of the front side of the cover 105 in certain embodiments can include one or both of a name 1 15 and logo 120 of the entity that order, sponsored and/or provided the coupon booklet 100. Other indicia, such as slogans and the title of the coupon book can also be provided.

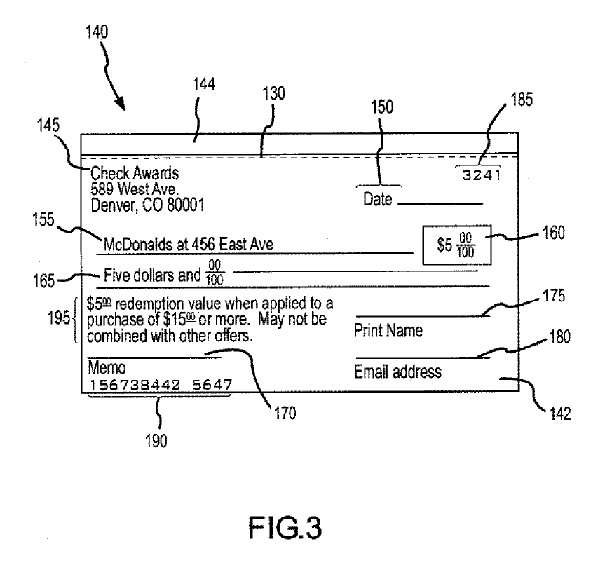

In FIG. 2 a typical coupon booklet insert 110 is shown. As indicated above the booklet insert is substantially similar to a typical personal bank checkbook insert. The booklet comprises a plurality of check-like coupons 140 (as illustrated in FIG. 3). Each check includes a perforated line 130 proximate its top lengthwise edge dividing the coupon into a thin strip 144 above the perforations and the printed portion of the coupon 142 located below the perforations. Typically, thirty or so coupons arc stacked together and aligned along with the rear sheet 122 and one or more front sheets, such as a welcome sheet 135 and a sheet providing a directory of coupons included in the booklet (not shown). The coupons are typically bound together along the thin strip by any suitable means, such as staples 132 or adhesive bonding. As is typical with personal bank checkbooks, a strip of cloth, plastic or paper adhesive tape 134 can be folded over the perforated strip portion of the bound stack to hide the staples or to give the booklet insert a more finished appearance. It is to be appreciated that the rear sheet 122 is often not perforated and it is made of heavier and stiffer paper stock than the coupons as it primarily serves to attach the booklet insert to the cover 105 by way of one of the cover's interior pockets.

The front welcome sheet 135 is shown in FIG. 2 and can include any indicia that the booklet's designer desires. Typically, the welcome sheet will include the name of the entity 115 that ordered, sponsored and/or provided the booklet and the entity's logo 120 as applicable. Further, the welcome sheet can include a slogan or thank you message aimed at the recipients of the booklet 100. The second page (not shown) of the booklet can include a directory of the coupons and/or additional indicia. A third page can be provided as well, if desired. A disclaimer and/or terms and conditions relating to the booklet and the coupons are typically provided on the front side or back side of one of the front sheets.

An embodiment of a typical coupon 140 is illustrated in FIG. 3. It is substantially similar to a personal bank check in its look and feel. It usually comprises paper of a similar type and weight as that of bank checks. Additionally, one or both of the front and back sides of the coupon can include a suitable background image. The layout of the coupons front side is also substantially similar to that of a typical check having: (i) an address section 145 in the upper left hand corner; (ii) a number 185 in the upper right hand corner that corresponds to a check number on a typical bank check; (iii) a date section 150; (iv) a payee line 155; (v) a monetary amount box 160 wherein the monetary value of the coupon is provided numerically; (vi) a corresponding monetary amount line 165 wherein the monetary value is alphanumerically printed out; (vii) a memo section 170; (viii) a user identification section 175 & 180 in the same location a signature line is provided in a typical check; and (ix) numerical information 190 printed along the bottom left of the coupon wherein ACH information would typically be provided on a bank check.

In the address section 145, the name and address of the coupon booklet's producer is typically provided. For instance, CheckAwards, LLC, the assignee of the present document, is listed on the illustrated coupon 140 along with their business address. Accordingly, if a recipient or other user of the booklet 100 or a coupon therefrom desires to design and have produced a customized booklet for an entity of which he/she is involved, the contact information for the producer is easily found. In other variations, the name and address can be that of the entity that is sponsoring and/or providing the booklet. In yet other variations, wherein the booklets are customized and printed specifically for the booklet's recipient, the recipient's name and address could be provided in this location. Of course, in other variations, the address section can be omitted altogether if so desired.

In some embodiments, the number 185 in the upper right hand corner of the coupon 140 along with the numerical information 190 provided in the bottom left of the coupon may have no specific meaning or significance other than to make the coupon appear more check-like. In yet other embodiments, either or both the number and the numerical information can be specifically encoded to provide identification and other information concerning one or more of the coupon's producer, the sponsor or providing entity, and the merchant. For example, the number or numerical information could also specify a region in which the coupon and associated booklet was distributed. Further, the number or numerical information could include a numerical identifier for the merchant providing the offer associated with the coupon. The number and numerical information might provide information concerning the date the coupon was produced. It is appreciated that the number and numerical information can also be used for other purposes as would be obvious to one of ordinary skill in the art given the benefit of this disclosure. The use of information encoded in the number or numerical information is described in greater detail herein below.

In the top right hand corner of the coupon 140, the date section 150 with a blank line is provided. While in some embodiments this section is provided primarily to make the coupon appear more like a check, in other embodiments, the vendor and/or user may fill this section out when the coupon is redeemed and the data concerning the coupons use can be utilized by one or more of the sponsor entity, the merchant and the producer.

The payee line 155 simply has the name and possibly the address of the vendor that is making the offer associated with the particular coupon 140. In certain instances, the payee line will not be long enough to include all the necessary and pertinent information concerning the vendor in which case additional information can be provided on the back side of the coupon. For example, where the vendor is a franchise of a larger chain, only particular location(s) owned by the franchise may be offering the discount represented on the coupon and accordingly the address(es) of the participating locations may have to be indicated on the back side of the coupon.

The monetary amount box 160 is provided and contains the numerical value of the coupon. In the corresponding monetary amount 165 line the value of the coupon is printed primarily in alphabetical characters. In a preferred embodiment, the savings amount of the coupon 140 is provided in a discreet monetary amount and not as a percentage. Accordingly, the perceived value of the coupon is increased as it has a set monetary value with the particular vendor subject to any conditions provided on the coupon. Further, by requiring the coupon to indicate only a set monetary amount, the check-like nature of the coupon is enhanced.

A memo section 170 is also provided primarily to enhance the check-like nature of the coupon. However, a vendor accepting the coupon 140 could use the space to make any particular notes related to the redemption of the coupon, such as the particular service or merchandise purchased by the consumer. Directly above the memo section in the space where a bank's address is usually listed on a bank check, the coupon includes indicia 195 that can indicate particular terms and/or conditions relating to the coupon and its redemption.

Finally, on the front face of the coupon in the lower right corner thereof, the user identification section 175 & 180 is provided. This section differs slightly from the signature line that is usually found on a typical bank check. On one embodiment of the coupon, two labeled lines are provided: one for the consumer's printed name 175; and one directly below it for the consumer's email address 180. The combination of the consumer's name and email address is particularly useful for the vendor as it can use this information to target this particular consumer in the future concerning other offers and advertising materials. The value of the consumer's email address is enhanced over email addresses bought as lists from list providers because the vendor knows that this particular consumer is specifically interested in the product and services the merchant offers as evidenced by the prior use of the coupon 140.

The Marketing Resource Center

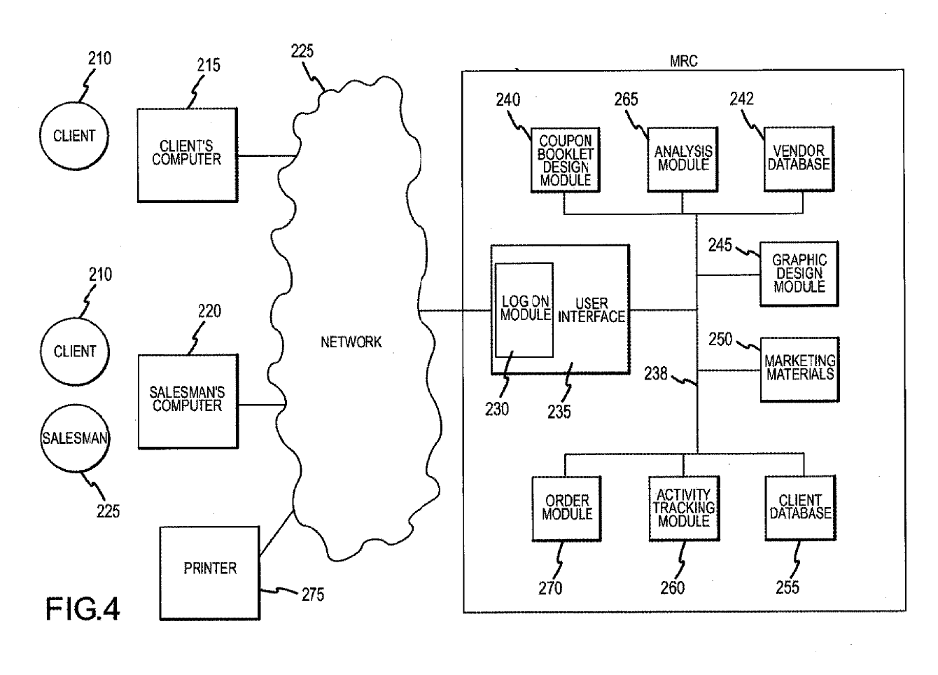

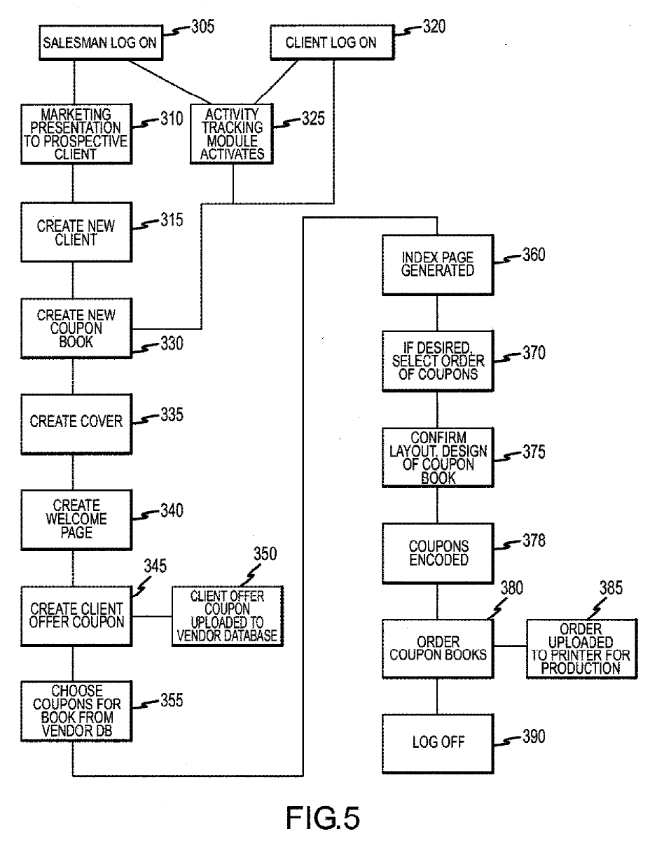

As mentioned above, the design, configuration, ordering and statistical analysis related to a particular booklet, entities sponsoring the booklet and merchants that have coupons included in the booklet are all managed using an integrated enterprise resource product (ERP) comprising a plurality of customized modules accessible through a common user interface. While variations and alternative embodiments can access the interface by any suitable means, such as by way of direct access with the computer where the various modules and information is stored, in at least one preferred embodiment, the user interface is accessed by way of a network connection. Any suitable ERP can be utilized; however, one suitable ERP is the Marketing Resource Center platform (MRC) produced by EagleXM, Inc. of Denver, Colo. FIG. 4 is a block diagram depicting the MRC 200 as customized for producing coupon booklets according to various embodiments.

It is to be understood that the various modules listed herein in reference to embodiments of the MRC may not describe specific software objects or routine. Rather, the functionality of the modules in alternative embodiments can be intermingled between various routines and objects. The use of the term modules is therefore not intended to limit the applicable software and hardware of the embodiments to a particular structure or configuration but is intended to indicate functionality present in the embodiment.

In certain preferred embodiments, the MRC 200 is accessed by a terminal or other network appliance including but not limited to laptop and desktop type personal computers, such as the computers 215 & 220 of a client 210 or salesperson 225. Accordingly, a salesperson tasked with selling coupon booklets 100 can complete the entire sales presentation, booklet design and customization, and booklet order processes from a client's location. Further, those clients that have had the appropriate training, such as those that have ordered booklets previously, may be provided access the MRC using their user name and password to facilitate: designing a new book; modifying a book already on file; changing its coupon offer(s); and ordering more booklets. Preferably, the network 225 utilized is the Internet, although private networks can be utilized in other variations and embodiments. Internet-based connections are usually encrypted to ensure the privacy of the data being transferred between the MRC and the applicable network appliances. Although a web browser running on the client's or salesman's network appliance 215 & 220 is used in certain embodiments to access the user interface 235 of the MRC, other programs can be utilized as well, such as an access program specifically designed to interface with the MRC.

Typically, a client or salesman will access the MRC 200 through a web-based user interface 235 having a logon module 230. The particular user name and password of the person logging on will determine the level of access the person has to the MRC. Clients 210 will typically have the lowest level of access and be able only to access information and data relating to its coupon booklet(s). For instance, the client may be able to access its client database entry and make necessary changes and corrections thereto but it will not typically be able to access the database entries of other clients or even be able to see what other clients are included in the client database. Further, while the client may be able to access the vendor database 242 to choose coupons, the client will not be able make any changes to the coupons excepting its own. A salesperson 225 will typically have the next level of access, which will often include access to information and data relating to his/her clients as well as access to any marketing materials that may be available on the MRC. A salesperson may also be able to sign up new clients and create accounts for them. Finally, managers or administrators will typically have the highest level of access giving them access to a significant portion if not the entirety of the information and data contained on the MRC as will as the ability to modify and change the data and information as necessary.

In preferred embodiments, the user interface 235 comprises a web enabled interface that can be viewed from any capable web browser (such as Explorer, Netscape, Foxfire and Opera) running on any suitable platform (such as Windows, Macintosh and Unix). The user interface is coupled with the other components and modules of the MRC 200 to facilitate communication therewith using any suitable standard or protocol as would be obvious to someone of ordinary skill in the art with the benefit of this disclosure. While all the components and modules of the MRC are illustrated as being located in a common box in FIG. 4, it is to be appreciated that, although it may, the MRC need not reside on a single computer, server or mass storage device. Rather, the various components and modules can be distributed over several servers, computers and mass storage devices. Accordingly, the pathways 238 indicated in FIG. 4 connecting the various modules and components with the user interface 235 can comprise the bus of a single computer or it can also comprise a network connection, such as but not limited to the Internet.

In certain preferred embodiments, the coupon booklet design module 240 comprises a menu driven interface in communication with the vendor database 242 and a particular client's folder in the client database 255 that permits the user to pick coupons and offers from the client's folder and the vendor database. Further, the coupon booklet design module permits the user to determine the order of the coupons in the booklet, as well as, make other booklet design choices, such as the color of the coupons or the cover. By interfacing with the graphics design module 245, the user can design specific coupons or offers related to the client. Further, by interfacing with the graphics design module the user can also design and configure the booklets cover and front sheets.

The graphics design module 245 comprises software and associated templates that permit a user via the user interface 235 to design individual coupons, the front sheets and the booklet's cover. Preferably, the coupons are designed to resemble bank checks as described above in greater detail, although the MRC 200 and its related operational methodologies could by applied to different types of coupon books, booklets and circulars as well. In variations, the graphics design module allows the user to upload logos and other materials in electronic format, such as but not limited to Gif, JPEG, Tiff and Bitmap, into the MRC for use in the cover, fronts sheets and/or client's coupons. While the graphic design module and coupon booklet design module 240 are shown as separate and distinct modules in FIG. 4, in other variations of the MRC they can comprise a unitary program or module.

Coupons created for and/or by a client are typically stored in the appropriate categories in the vendor database 242 as well as the client's folder in the client database 255. In some embodiments, any coupons designed by and/or for a particular client will be first stored in the client's folder with an electronic copy or relational marker being added to the appropriate categories in the vendor database only after the coupon is formally approved by a manager or administrator of the MRC 200.

The vendor database 242 comprises all the coupons available for inclusion in any coupon booklet. As indicated above, when a client creates one or more coupons for inclusion into its booklet, it has the option of adding the coupons to the vendor database. The coupons are typically categorized by such things as the industry to which the coupon pertains and the vendor offering the coupon. In certain embodiments, the vendor database may be searchable through one or both of the user interface 235 and the coupon booklet design module 240.

The vendor database 242 can be populated in any number of ways. The database can be populated by the producers soliciting business to provide offers in the database regardless of whether the vendors purchase or design coupon booklets for their own use. To entice large vendors to add coupons to the book, the producers may offer to provide information and statistics to the vendor on a periodic basis, such as information concerning the use of their coupons and verified email addresses of the customers who redeemed the vendor's coupons. The producers may provide vendors who want to add coupons to the database a way to do so via its website either directly through the MRC or by way of another web-accessible system. Overtime, however, one of the primary manners in which coupon offers are added to the database will be by way of coupon book clients adding offers that they are providing in their books to the vendor database.

The client database 255 contains all pertinent information concerning a particular client and the coupon booklets that have been designed for or by the client. Some the information contained in this database for each client may include: (i) the client's name and address; (ii) the client's industry; (iii) one or more contacts at the client; (iv) electronic file copies of the client's coupon booklets; (v) the client's account history; (vi) statistical data relating to the usage of coupon booklets distributed by the client; and (vii) the client's user name and password. Also, the client database can contain copies of coupons designed by the various clients specifically for inclusion into their own coupon books that the clients may opt not to have included in the vendor database 242.

As shown in FIG. 4, the client and vendor databases 255 & 242 are represented as two separate and distinct modules. It is to be appreciated that information for both clients and the vendors can be included in a single relational database wherein information and data retrieved from the database is dependent on a particular user interface screen and the query fields provided thereon. Similarly, the organization of the MRC generally and the database specifically can vary significantly and substantially as would be obvious to one of ordinary skill given the benefit of this disclosure.

Once a user has completed a booklet and wishes to have it printed he/she can utilize the order module 270 to choose the quantity of booklets he/she desires. The order module will tabulate the price and provide several payment methods. For example, a user may pay with a credit card, or have the money withdrawn directly from the client's account through direct withdrawal using the appropriate bank account's ACH information. In other situations for certain approved clients, the client may choose to be billed. The order information is then sent to a suitable printer 275 for fulfillment of the order. As shown, the printer can be located remotely from the MRC 200 wherein the information is transferred to the printer over a network, such as the Internet. In other embodiments the printing apparatus may be located contemporaneously with the MRC servers, such that the information can be downloaded to the printer via an intranet, such as the pathways 238 illustrated in the MRC.. In yet other embodiments, the data file for the coupon book can be downloaded on to computer readable media and physically delivered to a printer.

To assist in the marketing of the coupon booklet product, the MRC includes marketing materials 250 such as multimedia presentations that can be accessed by the salesperson through the user interface 235 to educate and inform a prospective client about the benefits of customized coupon booklets in general and in preferred embodiments, the use of checkbook-like coupon booklets. In one embodiment, the marketing materials include a PowerPoint presentation. By making the marketing materials available over the Internet, a salesperson can present professionally produced marketing materials to a prospective client from anywhere he/she can access the Internet without having to worry about forgetting his/her printed materials. The online marketing materials further benefit the managers of the coupon booklet producers as they can rest assured the appropriate marketing message is being presented to all prospective clients.

In preferred embodiments, the MRC 200 further includes an activity tracking module 260 accessible only by system administrators and/or managers that can track the activities of any registered users of the MRC. For instance, the administrators can verify that salespersons are making a sufficient and suitable number of sales calls based on how many times the salesperson accesses the marketing materials 250. They can further assess the successfulness of different marketing materials by correlating the use of the materials with the instances of prospective clients becoming actual clients. Further, the time spent on any particular portion of the marketing materials, such as a particular PowerPoint slide can indicate the portions of the marketing materials that are performing best or underperforming and require modification. The administrators can further determine the capabilities of their salespersons, such as how long a salesperson takes to train a new client concerning the use of the MRC and how long the salesperson requires to generate a customized coupon booklet for a new client. This information can be useful in determining whether certain salespersons are suited for the position or require additional training. Information and data concerning the clients can also be obtained such as how often clients return to the site to reorder. The tracking module may permit the administrators to determine which clients from what market and industry segments reorder more often versus those that do not. The information may be useful in helping improve a coupon booklet campaign for an underperforming client by comparing its success with statistics concerning other clients in similar market segments. The information can be utilized to improve the MRC interface, components and modules to be more effective and useful for the client and thereby maximize revenue generation.

Also included in preferred embodiments of the MRC 200 is an analysis module 265 that permits an authorized user, typically an agent of the booklet producer, to enter information received relative to redeemed coupons returned to the booklet producer. For instance, the user will enter in the email address provided by the person redeeming each coupon. The analysis module may include an email program that will then send an email to the particular address to verify that the address is an operational one. If the email is operational, the email address will be stored in a list for the particular vendor who provided the offer on the coupon. The list will be stored in the vendor's folder typically in the client database 255 or on another mass storage device to be retrieved and periodically sent to the vendor in whatever suitable format the vendor desires.

As discussed in greater detail below, the various numbers provided on the coupon can be encoded to contain information related to the coupons, such as the geographic region in which the coupons were distributed, the client who offered the coupon booklet in which the coupon was included, and the vendor who provided the coupon's offer. Encoding the vendor's identification information into the numbers may seem unnecessary considering that the vendor is listed on the face of the coupon; however, when dealing with large franchises the franchise offering the coupon will typically not be evident from the vendor name provided on the coupon's face.

The exact analysis performed by the analysis module 265 will depend on the nature of the data provided to the module as well as the desired type of information desired by requesters. For a large national vendor or client, statistics concerning the usage of specific coupons may be computed. For particular clients, data concerning which coupons in a particular booklet are being used and which are not being used may he provided. The exact nature of the analysis will in large part depend on what is potentially useful to the clients, the vendors and the booklet producer. As requested, the MRC administrators can tailor the analysis to fit a client's, vendor's or the producer's specific needs.

The analysis module 265 can also be used in conjunction with the activity tracking module 260 to analyze the data and generate suitable reports from the raw data acquired by the activity tracking module. Preferably, the reports can be customized to give the managers and administrators the type of information they desire and find useful concerning the management of the MRC 200 and the coupon booklet sales force.

Creating and Ordering Customized Coupon Booklets

Referring to FIG. 5, the process for creating and ordering a check-like coupon booklet 100 is provided in a flow chart 300. Typically, a potential client learns of the check-like coupon booklets through one of many means. For instance, a salesperson for the coupon book producer may cold call the potential client and setup an appointment for a visit to introduce the client to the product. In other instances, the potential client may come across the coupon booklets 100, perhaps receiving one, and contact the producer to express an interest in purchasing a customized booklet for his/her business or entity. In yet other instances, the client may become aware of the product based on visiting the producer's website. Further, third party telemarketing firms may be utilized to introduce potential clients of the coupon booklets.

Irrespective of how the prospective client becomes aware of the product, the producer will typically make an appointment for a salesman to visit with the client and discuss the benefits and features of the product. Typically, the salesman signs into the MRC 200 as indicated by block 305. In preferred embodiments, the salesman can pull marketing materials 250 from the MRC over the web to either his computer 220, such as a laptop, or the prospective client's computer 215 and utilize the material to make a sales presentation to the prospective client as indicated in block 310. The marketing material may include dynamic multimedia presentations, such as using PowerPoint and/or Macromedia, as well as written materials for downloading and printing. Further, the salesman may be able to access the vendor database 242 to show the prospective clients the types of coupons and offers available for his/her entity's coupon booklet. As discussed above and as indicated in block 325, any of the salesperson's access of the MRC is tracked so that the MRC administrators can, among other things, utilize the resulting data and information to improve the sales materials and assess the performance of the salesperson.

At some point in the sales process a user name and password may be assigned to the prospective client along with a folder for the entity in the client database 255 as shown in block 315. The user name and password are usually assigned by an administrator but in certain variations a salesperson may be able to create new users. The user name and password can be created before a salesperson goes to visit the prospective client so that the salesperson can immediately begin creating the client's coupon booklet should the prospective client express a desire to do so following the sales presentation. Alternatively, the user name and password can be subsequently created so that the coupon booklet can be created when the salesperson or other agent of the producer returns at a later scheduled date.

In certain variations, the client is never assigned a user name and password. Rather, the salesman or an agent of the producer may access the interface on behalf of the client to facilitate the design and ordering of booklets.

Referring to block 320, current clients 210 that have already created their first coupon booklet with a salesperson and have been properly trained concerning the use of the MRC 200 may be given the capability to log directly on to the MRC to design their own books and place orders therefore. In other variations, the clients will only be permitted to access the order module 270 to order booklets that were created with the assistance of an agent of the producer. In preferred embodiments, the activity of any client that is logged into the MRC is tracked by the activity tracking module 260 as shown in block 325.

As indicated in block 330, the user (either the salesperson for first time clients or the client itself) indicates on the web page displayed via the user interface 235 that he/she desires to create a new customized coupon booklet 100. It is to be appreciated that the actual layout and configuration of the various user pages rendered on the user's computer are not considered to be limited to any potential configuration and can vary with differing embodiments. Minimally, the display pages will include the appropriate information and capabilities necessary to carry out the creation of a coupon booklet.

Next, a page is displayed permitting the user to design a cover 105 of the coupon booklet 100 as indicated in block 335. Typically, the user will be able to pick the color of the cover; a name or title of the booklet to be printed on the cover; and a logo or other image to be displayed on the cover. The process of designing a coupon booklet in general and specific parts or sections, such as the cover, specifically will usually utilize one or both of the coupon book design module 240 and the graphics design module 245. While the flow chart of FIG. 5 depicts the creation of a coupon booklet in a certain specified order, it to be appreciated that the actual order of booklet creation can and may vary in other embodiments.

Referring to block 340, the welcome page 115 and any other front sheets of the booklet 100 are created. Like the cover 105, the welcome page can include: an entity's name; a title for the booklet; a logo or other image; and a welcome message. Depending on variations and other embodiments, additional or differing information can be provided as well. In some variations, the user may have full design control of the layout and content of the welcome page through the graphic design module 245. A typical, check-like coupon book is limited to a specific number of pages. For instance, the book may typically have up to 32 pages comprising the welcome page, a directory page and 30 coupons. In certain embodiments, a user may be able to add additional front sheets to provide additional necessary or desired information to the recipient of the booklet. For example, if the booklet is being sold by a youth soccer team to raise money, the booklet may contain a page or two that lists the game schedule for the team. Choosing to include more front sheets may or may not reduce the number of coupons 140 a user may include in the booklet.

In many instances, a client will want to provide one or more offers of their own related specifically to the booklet being created on their behalf and possibly for inclusion in the vendor database 242. The capability to create client coupons is provided by the MRC 200 as indicated in block 345. Typically, the user will be prompted whether or not he/she desires to include one or more client coupons or offers in the booklet. If the user answers yes, he/she may be prompted to provide the number of coupons he/she would like to include and the quantity to be included in the booklet of each coupon that is created. Typically, the user is then provided with one or more pages that interface with graphics design module 245, which will include a check-like template wherein the user can enter his/her offer.

Preferably, the graphics design module 245 and the associated template will limit the type of information a user may enter into any field to the type of information approved by the booklet producer. For example, in one embodiment, only monetary amount of offers are permitted, so if a user tries to design a coupon that provides a percentage discount the graphics design module will not permit a percentage to be entered in one or both the monetary amount box 160 and the monetary amount line 165. In other embodiments, the user may be able to generate any coupon he/she desires but the entire booklet in general and the client's coupons specifically may be reviewed by agents of the producers prior to sending the booklet to print to ensure proper compliance with any rules relating to the coupons or the booklet.

Referring to block 330 unless the user has indicated otherwise via an affirmative selection on one of the user interface pages relating to coupon creation, all coupons created by the user for the client will be added to the vendor database 242. Accordingly, these coupons can be included in the coupon booklets of other clients. In some embodiments, the user may select the appropriate categories in the vendor database for the newly created coupons. In yet other embodiments, an agent of the producers may review the coupon and list it in the appropriate vendor categories.

Next, the user chooses coupons from the vendor database 242 for inclusion in the client's coupon booklets as indicated in block 355. Coupons can be categorized in the vendor database using any desirable criteria. Most obviously, the coupons can be categorized by type, i.e restaurant, automotive, recreational activities, merchandise, etc. . . . The coupons can also be categorized by location. For instance in one embodiment, a user can enter in a desired location, such as that of the client, and the coupons could be categorized based on their distance from the location. Coupons can further be categorized by the names of the vendors themselves. Coupons can also be categorized based on the amount of the discount offered. Of course, the coupons can be categorized by other criteria as well as would be obvious to one of ordinary skill in the art with the benefit of this disclosure. In certain embodiments, the user can search for coupons in the database using multiple search criteria to more quickly narrow done the coupons to those he/she desires in the client's booklet.

Typically, the user will choose each coupon and indicate if more than one is to be included in the booklet. The order in which the coupons are chosen is usually their default order in terms of where they will appear in the completed booklet. Once all the coupons are chosen, a directory page is generated as indicated in block 360. The directory page typically is provided behind the welcome page 115 in the booklet. In preferred embodiments, the user by way of an appropriate web and/or interface page is given the opportunity to reorder the coupons. If he/she does so, a new directory page will be generated. Once the user is satisfied with the selection of coupons and their order in the booklet he/she indicates this by making the appropriate selection on the displayed page. In certain embodiments, the user then has the ability to review the entirety of the booklet online and confirm the booklet is designed to his/her satisfaction as indicated in block 375.

Normally, a user can pick up to 30 coupons in a standard check-like coupon booklet 100. Although at any point during the coupon selection process, the user may have the ability to end the coupon selection process with less than the full compliment of 30 coupons.

Referring to block 378, the number 185 and numerical information 190 provided on the face of each coupon 140 can be encoded automatically as determined by the MRC or as directed by the user or a combination of both. It is to be appreciated that numerical encoding may not be offered to all clients and vendors but rather reserved for only the largest of both. The types of information encoded on the coupons and which digits of the number 185 and numerical information 190 is encoded with what information can vary as would be obvious to one of ordinary skill in the art given the benefit of this disclosure. In certain embodiments, the encoding protocol for each vendor and client, as applicable, could be stored as a file in the entity's appropriate database folder(s) to be automatically retrieved and utilized by the MRC 200 to encode the coupons. For example, the number 185 in the upper right hand corner of each coupon may contain a number assigned to identify the particular client for whom a booklet is being designed. The numerical information provided on the bottom left corner of the coupon may be segmented wherein some of the digits are reserved for use by the client, such as to identify geographical distribution information, while other digits are reserved for the vendor to whom the offer on the coupon pertains. Further, a third set of digits may be reserved for the coupon booklet producer.

After the design and customization of the booklet is complete and as indicated in block 380, the user is then presented with an order page wherein he/she picks the number of books to be purchased. In one embodiment, the minimum order quantity is 100 booklets, but even smaller orders are possible in other embodiments. If the books are to be distributed to differing geographic regions and coupons are encoded with geographic information, the user may be requested to indicate the number to be distributed in each of the appropriate regions. Typically, the ordering module 270 will permit the client to pay for the coupons such as by credit card or direct bank withdrawal using ACH. Certain clients may be approved to make purchases on account and accordingly will not be required to tender payment upon ordering. Once the order is complete, the ordering module and the MRC will generate the necessary files and information to facilitate the printing and production of the coupon booklets. For instance, wherein encoded geographic information concerning the distribution of the booklets is included on the coupons booklets, the ordering module 270 will typically generate separate orders for each specified region to ensure that booklets from differing regions do not become co-mingled.

Referring to block 385, in some embodiments the ordering module 270 may send the print requests along with the necessary files in the appropriate electronic file format directly to a print spooler that is a component of the MRC 200 and the booklets will be automatically scheduled for printing on a printer directly networked with the MRC. In other embodiments, the print requests may be transmitted over the Internet to one or more printing companies for production and fulfillment of the order. In yet other variations, an agent is notified that the coupon booklet is ready for production so that the agent can review the information and files to determine their conformity with the producer's rules and policies. The agent can then send the files out to a printer 275, whether internal or external.

Coupon and Coupon Booklet Analysis Based on Redeemed Coupons

After printing, the booklets 100 are sent to the client for distribution however the client sees fit. In some instances the client may provide the booklets as a valuable giveaway to its customers as a promotion. In other instances, the booklets may be sold to raise funds. In their preferred form, the coupon books will typically have a very high perceived value as they very closely resemble a personal bank account checkbook including the vinyl cover. The actual manner in which the booklet is distributed is typically left to and the responsibility of the client for whom the book was produced.

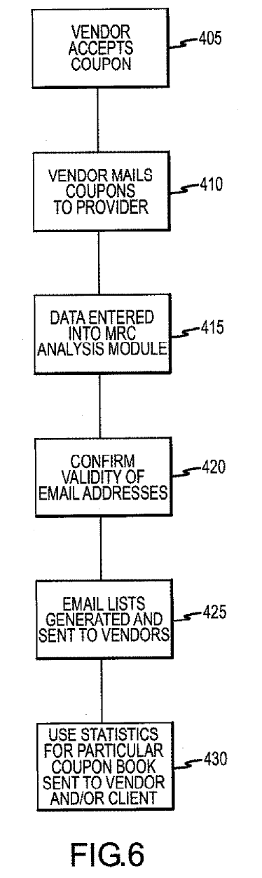

Referring to FIG. 6, a flow chart 400 is provided which illustrates the redemption of a coupon within a booklet by a consumer and more importantly how the redeemed coupon is processed by the booklets producer to provide one or both the client who provided the coupon in its booklet and the vendor making the offer on the coupon with information concerning the coupon's use.

First, as indicated in block 405, the consumer tenders the coupon for redemption. Per the vendor's agreement with the coupon booklet producer, the vendor is instructed to obtain both the consumer's name and email address in the appropriate spot on the coupon as a requirement of redemption.

Typically, vendors are provided with one or more postage paid envelopes from the coupon booklet producer and per their agreements with the coupon booklet producer; they are required to periodically send in the redeemed coupons to the producer as indicated in block 410. Of course, vendors having multiple locations may receive more than one envelope so that the vendor does not need to aggregate coupons from the various locations. Ultimately, one reason for providing the postage paid envelopes is to make it as easy as possible for the vendors to actually return the redeemed coupons to the producer. It is reasonably expected that a significant portion of the redeemed coupons will never be returned but by making the process of returning the coupons as easy and convenient as possible, the percentage of redeemed coupons returned will more likely be sufficient to permit accurate statistical analysis to be performed. Another incentive for certain vendors to return the coupons is that the producer will generate a list of confirmed email addresses that the vendor can then use in its future marketing activities.

Referring to block 415, the data contained on the coupon is entered into the appropriate locations in MRC 200 or into another database altogether. Typically, the written names and email addresses will need to be entered into a database manually using a data entry employees or contractors of the producer. As described above, the email addresses related to each vendor coupon are verified by the producer and formatted into an electronic file format and periodically provided to the vendor as further indicated by blocks 420 and 425. In variations, the email address information is typically processed for vendors of a significant size for free; whereas smaller vendors, such as single location merchant operations, may be able to receive the email lists by paying a fee to the producer.

Concerning any numerical data encoded on the coupons, it can also be entered manually via data entry. However, since in a preferred embodiment the form and format of the coupons are standardized, the producer using can automatically scan the checks into the MRC or other database and utilize optical character recognition (OCR) to decipher the associated numerical data on each coupon. In one embodiment, all coupons are scanned into the MRC or other system running suitable OCR and database programs; the numerical data is translated for each coupon; a scanned copy of the coupon along with the associated data is sent to a third party location for data entry personnel to read the email address off of the scanned copy and enter it into provided fields on the provided display page. The scanned coupon and associated data can then be sent to any location worldwide for negligible expense, and accordingly, data entry personnel in any part of the world can enter the email information into the associated database. As mentioned and described above in certain embodiments, the MRC or other associated system automatically verifies the email address and generates the appropriate lists to send to the vendors.

In some variations, bar codes can be provided on the coupon to facilitate data acquisition. The bar codes can contain any desirable encoded information similar to the information that can be encoded into the numerical data. Accordingly, the information can be retrieved by way of any appropriately configured bar code scanner.

Referring to block 430, the MRC 200 then performs the desired analysis on the information that was numerically encoded into each coupon and tabulates the results for use by one or more of the producer, applicable vendors and applicable merchants. For example, clients may desire information concerning the redemption rates of each coupon it included in a particular booklet. The client can determine which coupons and which types of coupons are more likely to be used by the recipients of the book. Accordingly, when ordering a new book, the client can avoid coupons of the type that the recipients did not use and more of the type the recipients did use, thereby making the booklet potentially more valuable to the recipients. The producer can use similar information aggregated and categorized in a multitude of ways to help advise a client concerning what types of coupons are used most often by people in its geographic region that are of the type of consumer or recipient the client is targeting. Vendors may use the information to determine what coupon offers are performing well compared to those that are underperforming. Accordingly, they can tailor the offer on future coupons to maximize their effectiveness in drawing consumers to their establishment. It is to be appreciated that the data can be tabulated and analyzed in any of a myriad of ways to provide useful information to vendors, clients and the producer.

### Alterative Embodiments and Other Variations

The embodiments of the exercise device as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure.

In one alternative embodiment, the check-like coupons can be provided in a larger coupon book similar in form and function to commercial checkbooks that utilize ring binders. In variations of the check-like coupons, the identification section could vary significantly and substantially as would be obvious to one of ordinary skill in the art given the benefit of this disclosure. For instance, space may be provided to enter the coupon redeemer's physical address in addition to or in lieu of the email address.

Concerning the ERP generally and the described MRC specifically, their form can vary significantly while offering similar functionality. For instance, the Analysis of returned and redeemed coupons can be performed on a computer system completely remote from the system used to design and order the coupon booklets. The two systems need not even be connected via a network. It is to be understood that the various modules listed above in some embodiments may not describe specific software objects or routine. Rather, the functionality of the modules in alternative embodiments can be intermingled between various routines and objects.

The order of the operations presented concerning the methods of both designing and producing a coupon booklet are merely suggested. It is to be appreciated that the actual order of the operations can vary while providing similar results. It is to be further appreciated that some of the operations presented in the exemplary methods above can be eliminated and skill provide for the creation and use of customized coupon booklets. For example, the activity tracking operations can be eliminated in some variations.

In some variations, the MRC can be used to prepare the coupon books for distribution to a particular set of individuals or entities. For instance, if a mail list is provided to the MRC relating to a particular set of booklets, the MRC can print out personalized letters for each of the booklet recipients as well as print any required mailing materials with the delivery address. Accordingly, the books can be delivered from the producer without the involvement of the client save for the design of the book and the preparation of the mailing list.

We claim:

1. An Enterprise Resource Product (ERP) installed on one or more first computer systems of a coupon book producer for the design of a customized coupon book, the ERP comprising:
a user interface, the user interface facilitating communication between a second computer system and the ERP by way of a network connection;
log-on functionality, the log-on functionality facilitating a client to access the ERP by the second computer system by way of the network connection upon confirmation of credentials provided by the client;
a vendor database, the vendor database including all coupons available for inclusion into the customized coupon book;
coupon book design functionality, the coupon book design functionality facilitating the client through the second computer system to select specific coupons from the vendor database for inclusion in customized coupon book; and
ordering functionality, the ordering functionality facilitating the client to order copies of the customized coupon book.

2. The ERP of claim 1, further comprising:
graphic design functionality, the graphic design functionality facilitating the client to design of one or more coupons concerning offers by the client for inclusion in the customized coupon book.

3. The ERP of claim 2, wherein the graphic design functionality is further adapted to facilitate the design of a cover of the customized coupon booklet.

4. The ERP of claim 1 further comprising activity tracking functionality, wherein the activity tracking functionality monitors activities of the client within the ERP.

5. The ERP of claim 1 further including a client database, the client database including information pertaining to customized coupon books generated by the client.

6. The ERP of claim 5 wherein the client database and the vendor database comprise a single relational database.

7. The ERP of claim 4 further comprising data analysis functionality, the data analysis functionality adapted to analyze data obtained by the activity tracking functionality and generate reports therefrom.

8. The ERP of claim 1 further comprising data analysis functionality, wherein the user interface is further adapted to receive data concerning the usage of coupons from the customized coupon book and provide analysis for use by the client and/or the vendor who had coupons included in the customized coupon book.

9. A method for a client to create a customized coupon book over a communications network, the method comprising:
logging on by way of the communications network to a system running coupon book design software; and
selecting a plurality of coupons from a database associated with the coupon book design software.

10. The method of claim 9, further comprising:
creating a customized cover over the communications network for the customized coupon book, the customized cover including at least one of (i) a name of the client, and (ii) a logo associated with the client.

11. The method of claim 9, further comprising:
creating a new coupon over the communications network concerning an offer by the entity and including the new coupon in the customized coupon book.

12. The method of claim 9, further comprising:
creating a welcome page over the communications network having customized message provided thereon relating to the entity.

13. The method of claim 9, further comprising:
selecting the order of appearance of the coupons selected for inclusion in the coupon book over the communications network.

14. The method of claim 9, further comprising:
ordering a desired number of customized coupon books over the communications network.

15. The method of claim 14, further comprising:
paying for the order of customized coupon books over the communications network.

16. A method of providing a customized coupon book, the method comprising:
providing software resident on a system comprising one or more computers, the software including at least (i) coupon book design functionality to facilitate creation of the customized coupon book, (ii) a database of a plurality of coupons available for inclusion in the customized coupon book, and (iii) a user interface connected to a communications network permitting a client to utilize the software from a remote computer;
granting the client access to the software over the communications network; and
creating the customized coupon book includes coupons chosen by the client from the plurality of coupons for inclusion in the customized coupon book.

17. The method of claim 16, wherein said “creating the customized coupon book” further includes:
configuring a custom cover based on client input provided over the communications network; and
configuring a welcome page with a client provided message.

18. The method of claim 16, further comprising:
creating a new coupon based on offer details provided by the client over the communications network.

19. The method of claim 16, further comprising:
accepting and processing an order for a plurality of the customized coupon books over the communications network.

20. The method of claim 16 further comprising:
providing a bar code and/or numerical sequence on each coupon included in the customized coupon book, the bar code and/or number being encoded with information concerning at least one of (i) the customized coupon book the coupon was offered in; and (ii) the geographic area in which the customized coupon book was distributed.
